(19) United States
(12) Patent Application Publication
(10) Pub. No.: US 2026/0106496 A1
(43) Pub. Date: Apr. 16, 2026

(54) Traction motor with Bonded Magnets

(71) Applicant: ABB Schweiz AG, Baden (CH)

(72) Inventors: Elio Alberto Perigo, Wendell, NC (US); Darren Dale Tremelling, Apex, NC (US)

(21) Appl. No.: 18/913,689

(22) Filed: Oct. 11, 2024

(51) Int. Cl. H02K 1/02; H02K 1/272; H02K 1/32

(52) U.S. Cl. CPC H02K 1/02; H02K 1/272; H02K 1/32

(57) ABSTRACT

A traction motor including a rotor with one or more magnet cavities, each configured to receive at least one magnet. The traction motor includes one or more Mn—Bi magnets positioned within the one or more magnet cavities. The traction motor includes one or more stators positioned opposite from the one or more Mn—Bi magnets. The one or more Mn—Bi magnets are shaped into a desired profile.

### FIELD OF THE DISCLOSURE

The field of disclosure relates generally to traction motors with bonded magnets and, more particularly, traction motors having a rotor where the rotor includes a bonded Mn—Bi magnet.

### BACKGROUND OF THE DISCLOSURE

Traction motors convert electrical energy to rotatory motion and typically produce higher torque at lower speeds and lower torque at higher speeds. Traditionally, traction motors utilize either induction, wound field, or permanent magnet topologies to produce the desired output torque below a base speed, and constant power capability above a base speed for a constant power speed ratio of at least two (2), preferably three (3) or more.

However, traditional traction motors have shortcomings that are often accepted in view of the traditional traction motor's capabilities. For example, induction traction motors are relatively cost effective to manufacture but are not efficient or power dense. In contrast, wound field and permanent magnet traction motors are power dense and efficient, but are complex and expensive to manufacture.

Traditional magnets for traction motors are frequently rectangular-shaped. The rectangular-shaped magnets require limited secondary processing during manufacturing and as a result are a cost effective option for use in traction motors. For example, grinding of the rectangular magnet to a desired shape is not required. However, a rectangular-shaped magnet limits saliency and overload-ability due to their inherent disturbance of flux paths optimized for reluctance structure. For example, sintered magnets are commonly used in traction motors and the use of block magnets, which is preferred from sintering and machining requirements, limits magnetic anisotropy of the reluctance structure, and as a result, limits the delivered output power of the traction motor and has a higher cost.

Based on the foregoing, a need exists for a traction motor that utilizes a motor construction that is simple and cost effective to manufacture and delivers high torque density.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### SUMMARY OF THE DISCLOSURE

The present disclosure describes a traction motor including a rotor with one or more magnet cavities, each configured to receive at least one magnet. The traction motor includes one or more Mn—Bi magnets positioned within the one or more magnet cavities. The traction motor includes one or more stators positioned opposite from the one or more Mn—Bi magnets. The one or more Mn—Bi magnets are shaped into a desired profile.

The present disclosure also describes a traction motor including a rotor with a bonded Mn—Bi magnet, and a stator positioned opposite from the bonded Mn—Bi magnet.

The present disclosure also describes a traction motor including a rotor with two or more rotor stacks positioned axially along a longitudinal axis, each rotor stack is separated by a gap. Each rotor stack includes a plurality of magnet cavities spaced around the longitudinal axis, each magnet cavity configured to receive at least one magnet. The rotor includes at least one air duct opening extending axially relative to the longitudinal axis, wherein the at least one air duct opening and each gap are in communication therewith. The traction motor includes one or more Mn—Bi magnets positioned within the each magnet cavity, and one or more stators positioned opposite from the one or more Mn—Bi magnets. The one or more Mn—Bi magnets are shaped into a desired profile.

As used herein, “a”, “an”, and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the one or more embodiments of the disclosure described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, “side”, “left”, “right”, “rear”, “top”, “bottom”, and the like, are used for ease of description to describe one element or feature's relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

As used herein, the terms “comprise(s)”, “comprising”, and the like, specify the presence of stated features, integers, steps, operations, elements, and/or components, but do not preclude the presence or addition of one or more other features, integers, steps, operations, elements, components, and/or groups thereof.

As used herein, the terms “configure(s)”, “configuring”, and the like, refer to the capability of a component and/or assembly, but do not preclude the presence or addition of other capabilities, features, components, elements, operations, and any combinations thereof.

Chemical compounds are described using standard nomenclature. For example, any position not substituted by any indicated group is understood to have its valency filled by a bond as indicated, or a by hydrogen atom.

All ranges disclosed herein are inclusive of the endpoints, and the endpoints are independently combinable with each other. Each range disclosed herein constitutes a disclosure of any point or sub-range lying within the disclosed range.

All methods described herein can be performed in any suitable order unless otherwise indicated herein or otherwise clearly contradicted by context. The use of any and all examples, or exemplary language (e.g., “such as”), is intended merely to better illustrate the present disclosure and does not pose a limitation on the scope of the present disclosure or any embodiments unless otherwise claimed.

Any combination or permutation of features, functions and/or embodiments as disclosed herein is envisioned. Additional advantageous features, functions and applications of the disclosed systems, methods and assemblies of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

Features and aspects of embodiments are described below with reference to the accompanying drawings, in which elements are not necessarily depicted to scale. Corresponding reference characters indicate corresponding parts throughout the several views of the drawings.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure.

To assist those of ordinary skill in the art in making and using the disclosed assemblies, systems and methods, reference is made to the appended figures, wherein:

FIG. 1 depicts a perspective view of an assembled traction motor, according to the present disclosure;

FIG. 2A depicts a exploded left perspective view of a rotor of the assembled traction motor of FIG. 1, including a magnet;

FIG. 2B depicts a exploded right perspective view of the rotor of FIG. 2A;

FIG. 3 depicts a partial cross-sectional view of the assembled rotor and stator of the traction motor of FIG. 1;

FIG. 4 illustrates a graph of magnet health as a function of Bminlim for permanent magnet derived bonded Mn—Bi traction motors under high torque loading, where magnet health [%] is shown along the Y-axis and the demagnetization point [T] is shown along the X-axis;

FIG. 5 illustrates a graph of the magnetic properties of bonded ferrite, sintered ferrite, bonded Sm—Fe—N, and bonded Mn—Bi, commonly referred to as a B-H curve, where B (y-axis) represent flux density and H (x-axis) represents magnetizing force;

FIG. 6 illustrates a graph of the B-H curve of bonded Mn—Bi (6C) at room temperature and elevated temperatures;

FIG. 7 depicts a cross-sectional view of magnetic cavities of the traction motor of FIG. 1;

FIG. 8 depicts a cross-sectional view of magnetic cavities of the traction motor of FIG. 1;

FIG. 9 depicts a cross-sectional view of magnetic cavities of the traction motor of FIG. 1; and

FIG. 10 depicts a perspective view of a stacked rotor of the assembled traction motor of FIG. 1.

### DETAILED DESCRIPTION OF THE DISCLOSURE

The exemplary embodiments disclosed herein describe an advantageous traction motor including one or more magnets. Specifically, a synchronous reluctance traction motor that is magnet assisted. The traction motor is configured for use in environments where high torque may be required. However, it should be understood that the traction motor described herein may be used in a variety of environments and is not limited to only environments where high torque may be required. The traction motor provides constant power above a certain speed. The power and speed outputs may depend on the design parameters of the traction motor, including but not limited to, the rotor dimension, the rotor anisotropy, pole number, and combinations thereof.

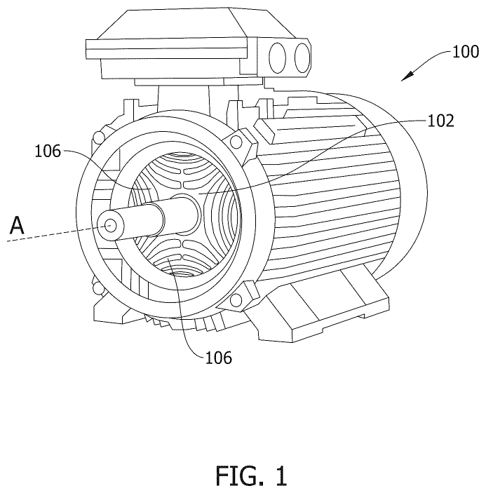

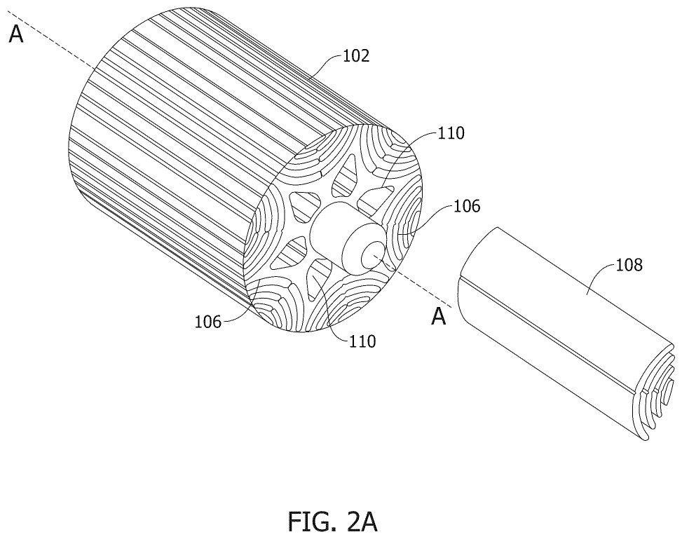

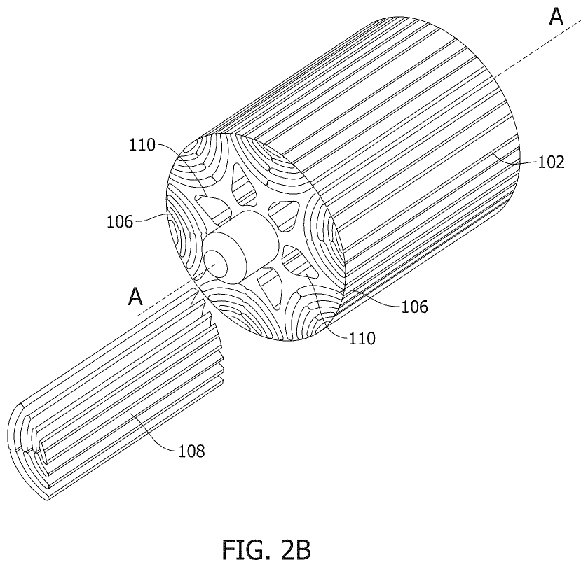

Referring to FIGS. 1-3, a traction motor 100 includes a rotor 102, a stator 104, and at least one magnet 108 positioned in proximity to the stator 104. FIG. 1 depicts the assembled traction motor 100 with select components visible, including the rotor 102 and at least one magnet cavity 106. FIGS. 2A and 2B depict the rotor 102 and the at least one magnet 108 aligned axial to axis A of the rotor in an exploded view. The at least one magnet 108 is axially aligned with a corresponding cavity 106 and is positionable within the corresponding cavity 106. It should be understood that additional magnets 108 may be positioned within the corresponding cavities 106, as described herein. Air may flow axial to the axis A along the interior of the rotor 102. For example, air may flow through air duct openings 110 positioned around axis A and extending longitudinally through the rotor 102. The air duct openings 110 may define a cross-sectional shape that includes, but is not limited to, a rectangle, square, triangle, diamond, circle, and combinations thereof.

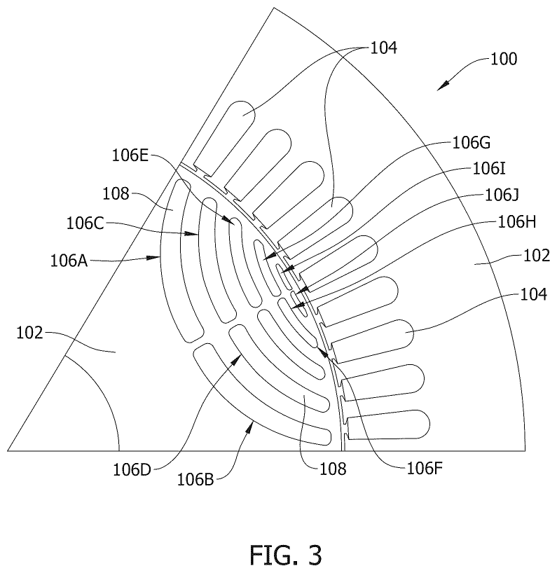

Portions of the stator 104 and the rotor 102 are shown in FIG. 3. In addition to the stator segment shown in FIG. 3, the complete stator 104 may have a toroidal shaped-body with a hollow central portion configured to receive a cylindrical rotor 102 located in the hollow central portion of the stator. The rotor 102 includes a plurality of like wedges 102, that collectively form the cylindrical rotor body. The rotor 102 may include a select number of wedges (n), such as, but not limited to, between about 2 and about 20. For example, the rotor 102 may include four (4) wedges 102, six (6) wedges 102, eight (8) wedges 102, or ten (10) wedges 102. However, it should be understood that the number of wedges of the rotor 102 may vary without departing from the spirit/scope of this disclosure.

The exemplary wedge of rotor 102 in FIG. 3 includes a plurality of cavities 106 that are located proximate the rotor periphery. The complete rotor 102 is depicted in FIGS. 1, 2A, and 2B which include the plurality of cavities 106. The cavities extend longitudinally through the rotor body between the ends of the rotor and along axis A. In the embodiment of the disclosure, the rotor wedge includes ten discrete cavities 106 A-106 J. As shown in FIG. 3, each cavity 106 has a generally arcuate laterally-extending shape and each cavity extends laterally from a location proximate the outer rotor periphery to a position inward from the periphery. The arc lengths of cavities 106 A, 106B, 106C, 106 D, 106 E, 106 F, 106 G, 106 H, 106 I, and 106 J decrease in magnitude from the radially inwardly cavities 106 A, 106 B having the greatest magnitude arc lengths to the cavities 106 I, 106 J with the minimum magnitude located radially outwardly near the rotor periphery. Any suitable shaped cavities and cavity configuration may be used. As shown in FIG. 3, the stator 102 includes a plurality of stator slots, extending longitudinally axially. Each slot is configured to receive a member that is drawn to magnets 108. The traction motor 100 may include a plurality of magnets 108 positioned in proximity to the stator 104. Each of the plurality of magnets 108 may be positioned within a corresponding magnet cavity 106. In some instances, two or more of the plurality of magnets 108 may be positioned within the magnet cavity 106.

The magnets 108 are fabricated from chemicals including manganese (Mn) and bismuth (Bi), collectively referred to as Mn—Bi. The magnets 108 are fabricated using bonded Mn—Bi. The quantity of Mn and the quantity of Bi to fabricate magnets 108 may vary. For example, the magnets 108 may include about 40 percent atom (% at.) to about 60% at. of Mn. The magnets 108 may include about 40% at. to about 60% at. of Bi. In some embodiments, the ratio of Mn to Bi may be a 1:1 ratio. It is commonly considered that bonded magnets are inappropriate for high power density motors (such as traction motors). That is because bonded magnets traditionally have possessed limited intrinsic coercivity that is insufficient for traction motors nor significant magnetic remanence needed for torque dense applications. However, bonded Mn—Bi magnets has increased intrinsic coercivity, at increased temperatures, and thereby increasing the effectiveness of the bonded magnets and ultimately the traction motor, while use in a reluctance based rotor allow for high magnetic loading of the machine, with acceptable power factor. The bonded Mn—Bi magnets may include a particle size of less than or equal to about 10 microns. In some embodiments, the bonded Mn—Bi magnets may include a particle size that is about 0.5 microns to about 5 microns.

Tables 1 and 2 (below) compare efficiency and power factors for a number of operating points with characteristics of bonded Mn—Bi assisted reluctance motor shown compared to a reference sintered permanent magnet (PM) machine. The delta values (A) indicate variation with the Mn—Bi implementation. Thus, the numbers depicted correlate to the bonded Mn—Bi assisted reluctance motor with the delta value (A) already included.

TABLE 1
Bonded Mn—Bi assisted SynRm motor compared to reference PM traction motor.

| Speed | ~.8x | | 1.0x | | 2.25x | |
|---|---|---|---|---|---|---|
| Power | 1.5x | | 1.0x | | 1.0x | |
| Efficiency | 94.0% | (Δ =+ 0.5) | 96.3% | (Δ =− 0.2) | 95.0% | (Δ =+ 1.5) |
| Cosphi | 0.77 | (Δ =+ 0.03) | 0.88 | (Δ =− 0.04) | 0.96 | (Δ =− 0.04) |

TABLE 2
Bonded Mn—Bi assisted SynRm motor compared
to reference induction traction motor.

| Speed | ~.8x | | 1.0x | | 2.25x | |
|---|---|---|---|---|---|---|
| Power | 1.5x | | 1.0x | | 1.0x | |
| Efficiency | 95.4% | (Δ =+ 3.9) | 96.6% | (Δ =+ 3.0) | 96.8% | (Δ =+ 5.3) |
| Cosphi | 0.77 | (Δ =+ 0.04) | 0.87 | (Δ =+ 0.05) | 0.99 | (Δ =+ 0.17) |

As illustrated by the comparative data in Tables 1 and 2, the bonded Mn—Bi magnets produce a higher efficiency versus the reference sintered PM machine. A higher efficiency correlates to a reduced energy consumption and a lower operating cost, as compared to the reference PM machine.

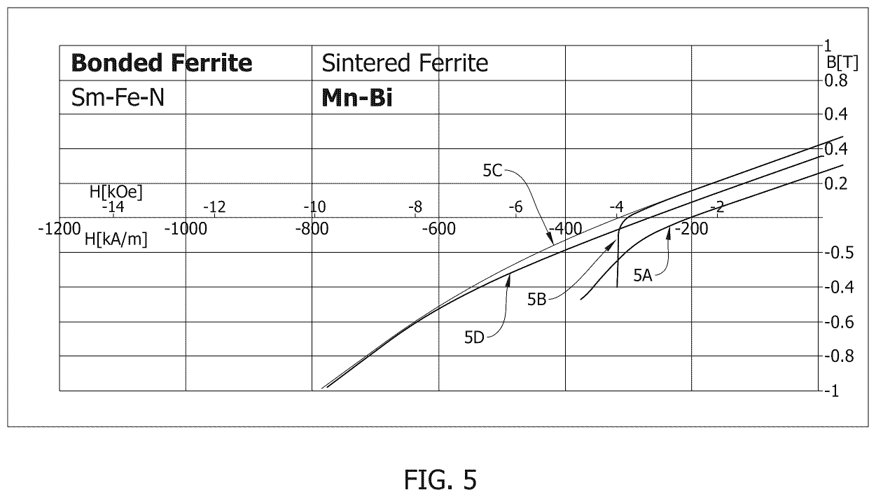

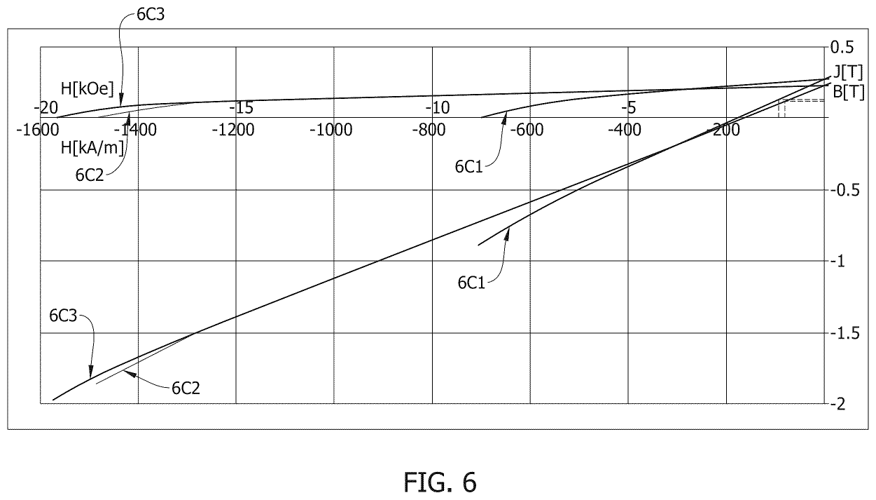

Referring to FIG. 5, the graph illustrates test data by the Applicant of the magnetic properties of several materials, commonly referred to as a B-H curve, where B (y-axis) represent flux density and H (x-axis) represents magnetizing force. Specifically, the B-H curve of bonded ferrite (5A), sintered ferrite (5B), bonded Sm—Fe—N (5C), and bonded Mn—Bi (5D), each at room temperature. Referring to the graph, bonded ferrite (5A) and sintered ferrite (5B) as the flux density decreases, the magnetizing force decreases sharply. However, the bonded Sm—Fe—N (5C) and the bonded Mn—Bi (5D) display a higher magnetizing force as the flux density decreases. Although the bonded Sm—Fe—N (5C) and the bonded Mn—Bi (5D) display a similar B-H curve at room temperature, the intrinsic coercivity of Sm—Fe—N drops at higher temperature as compared to the bonded Mn—Bi. Referring to FIG. 6, the graph illustrates test data by the Applicant of the B-H curve of bonded Mn—Bi (6C) at room temperature and elevated temperatures. Reference 6C1 was conducted at 25° C., reference 6C2 was conducted at 124° C., and reference 6C3 was conducted at 171° C.

The Mn—Bi bonded magnets enable design flexibility relative to the shape of the cavities 106, and associated magnets 108 located in the cavities. The magnets 108 may be formed into any suitable shape that yields the required performance output of the traction motor. The plurality of magnets 108 may be sized and shaped to enable the magnets to align with the magnetic material of the stator 104, and thereby enhance traction motor operation. In this way, the magnets will associate with the peripheral shape and configuration of magnetic material along the stator 104. The magnets 108 may define a shape that is rectangular, arc-shaped, and combinations thereof. The plurality of magnet cavities 106 may define a size and shape that resembles the at least one magnet 108.

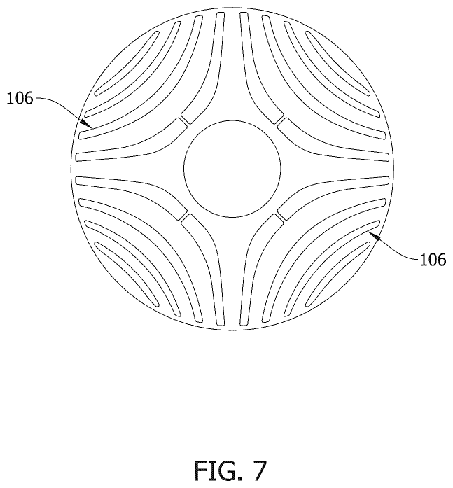

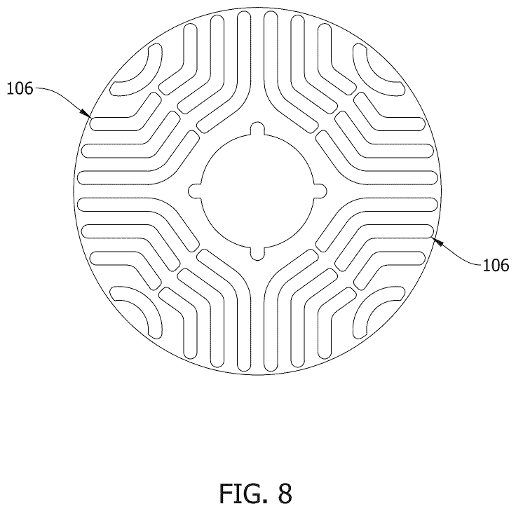

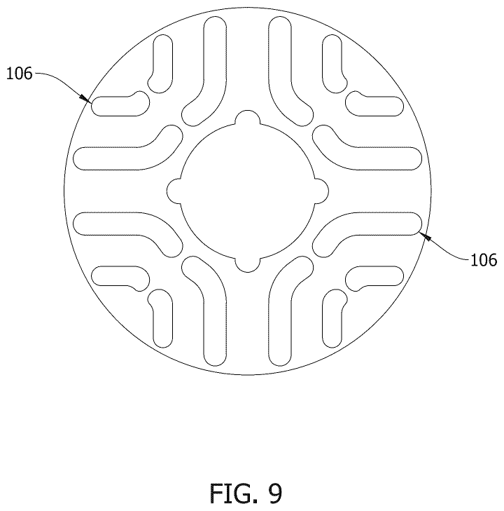

The magnets 108 may be fabricated into the desired shape by net shape molding or otherwise net shape manufacturing the magnets 108. With net shaping the magnets 108, the magnets 108 do not require shaping or grinding to achieve the desired shape. In some instances, the magnet cavities 106 may be utilized as a mold to shape the magnets 108. The bonded Mn—Bi material is added to the magnetic cavities 106 with a magnetic aligning field applied. The material is then compressed to form the magnets 108. In some instances, the magnets 108 may be fabricated by a combination of net shaping and molding. FIGS. 7-9 are cross-sectional views depicting variously-shaped magnet cavities 106. The magnets 108 may be fabricated into the shape of the magnet cavity 106, as shown in the figures. Thus, the cavities 106 accommodate the shaping of the magnets 108 by gradual variation of the thickness along the magnet 108 (e.g., along the curvature), and limits effect of stress concentrations by incorporating fillets along the magnet corners.

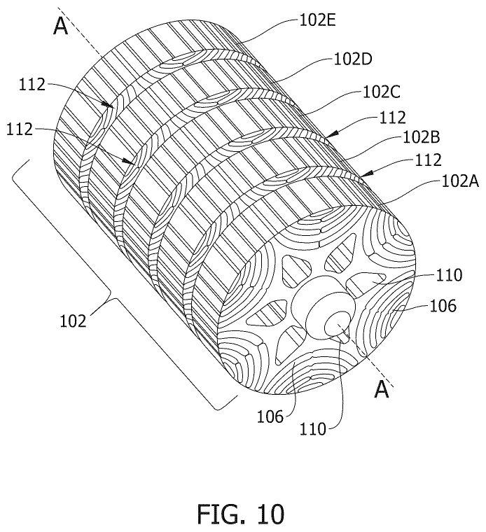

In some instances, the rotor 102 may be separated into a series of rotor stacks and there may be N number of rotor stacks. Referring to FIG. 10, the rotor 102 includes five (5) rotor stacks 102A, 102B, 102C, 102D, 102E and each rotor stack 102 is separated by a gap 112. It should be understood that each rotor stack 102A, 102B, 102C, 102D, 102E may include one or more magnets 108 and one or more corresponding cavities 106, as described herein. The one or more gaps 112 and the air duct openings 110 may be in fluid communication with each other. For example, air may flow through the air duct openings 110 along the axis A and exit from one or more of the gaps 112. The air duct openings 110 and/or the gaps 112 may promote uniform cooling from within the rotor 102. The gaps may define a width along the longitudinal axis A that is between about 2 mm and about 12 mm.

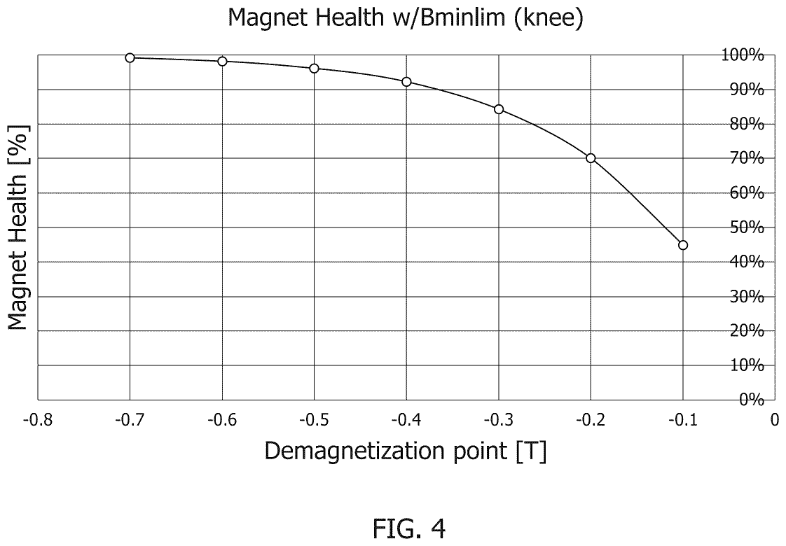

Referring to FIG. 4, the graph illustrates first demagnetization analysis with Bminlim parameter. Magnet health remains high at flux density levels within linear regimes. FIG. 4 indicates the magnetic health of the Mn—Bi bonded magnets against the demagnetization point. The Mn—Bi bonded magnets begin to demagnetize at −0.4 T.

While the disclosure has been described with reference to preferred embodiments, it will be understood by those skilled in the art that various changes may be made, and equivalents may be substituted for the elements thereof without departing from the scope of the disclosure. In addition, many modifications may be made to adapt the teaching of the disclosure to particular use, application, manufacturing conditions, use conditions, composition, medium, size, and/or materials without departing from the essential scope and spirit of the disclosure. Therefore, it is intended that this disclosure is not limited to the exemplary embodiments and best mode contemplated for carrying out the embodiments of this disclosure as described herein. Since many modifications, variations, and changes in detail can be made to the described examples, it is intended that all matters in the preceding description and shown in the accompanying figures be interpreted as illustrative and not in a limiting sense.

1. A traction motor comprising:
a rotor comprising one or more magnet cavities, each configured to receive at least one magnet;
one or more Mn—Bi magnets positioned within the one or more magnet cavities; and
one or more stators positioned opposite from the one or more Mn—Bi magnets;
wherein the one or more Mn—Bi magnets are shaped into a desired profile.

2. The traction motor according to claim 1, wherein the one or more Mn—Bi magnets are shaped into an arc-shaped profile, a rectangular-shaped profile, and combinations thereof.

3. The traction motor according to claim 1, wherein a material of the one or more Mn—Bi magnets is added into the one or more magnet cavities to mold the one or more Mn—Bi magnets.

4. The traction motor according to claim 1, wherein the one or more Mn—Bi magnets are bonded Mn—Bi magnets.

5. The traction motor according to claim 1 further comprising an air duct opening extending axially along the rotor.

6. The traction motor according to claim 1, wherein the Mn—Bi magnet is fabricated from about 40% at. to about 60% at. of Mn and about 40% at. to about 60% at. of Bi.

7. The traction motor according to claim 1, wherein the Mn—Bi magnets comprise a particle size of less than or equal to about 10 microns.

8. The traction motor according to claim 7, wherein the Mn—Bi magnets comprise a particle size of about 0.5 microns to about 5 microns.

9. The traction motor according to claim 1, wherein the one or more Mn—Bi magnets are sintered Mn—Bi magnets.

10. The traction motor according to claim 1, wherein the rotor comprises two or more rotor stacks positioned axially relative to each other, wherein each rotor stack is separated by a gap.

11. A traction motor comprising:
a rotor comprising a bonded Mn—Bi magnet; and
a stator positioned opposite from the bonded Mn—Bi magnet.

12. The traction motor according to claim 11 further comprising a magnet cavity configured to receive the bonded Mn—Bi magnet.

13. The traction motor according to claim 11, wherein the bonded Mn—Bi magnet is shaped into a desired profile.

14. The traction motor according to claim 13, wherein the bonded Mn—Bi magnet is shaped into an arc-shaped profile, a rectangular-shaped profile, and combinations thereof.

15. The traction motor according to claim 12, wherein a material of the bonded Mn—Bi magnet is added into the magnet cavity to mold the bonded Mn—Bi magnet.

16. The traction motor according to claim 11, wherein the rotor comprises an air duct opening extending axially along the rotor.

17. The traction motor according to claim 11, wherein the bonded Mn—Bi magnet is fabricated from about 40% at. to about 60% at. of Mn and about 40% at. to about 60% at. of Bi.

18. The traction motor according to claim 11, wherein the bonded Mn—Bi magnet comprises a particle size of less than or equal to about 10 microns.

19. The traction motor according to claim 18, wherein the bonded Mn—Bi magnet comprises a particle size of about 0.5 microns to about 5 microns.

20. A traction motor comprising:
a rotor comprising two or more rotor stacks positioned axially along a longitudinal axis, each rotor stack is separated by a gap, wherein each rotor stack comprises a plurality of magnet cavities spaced around the longitudinal axis, each magnet cavity configured to receive at least one magnet, wherein the rotor comprises at least one air duct opening extending axially relative to the longitudinal axis, wherein the at least one air duct opening and each gap are in communication therewith;
one or more Mn—Bi magnets positioned within the each magnet cavity; and
one or more stators positioned opposite from the one or more Mn—Bi magnets;
wherein the one or more Mn—Bi magnets are shaped into a desired profile.
